(19) United States
(12) Patent Application Publication
(10) Pub. No.: US 2007/0052892 A1
(43) Pub. Date: Mar. 8, 2007

(54) Rubbing apparatus and method for producing optical sheet

(75) Inventors: Makoto Tanaka, Odawara-shi (JP); Hidetoshi Kawasaki, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/514,888

(22) Filed: Sep. 5, 2006

(30) Foreign Application Priority Data
Sep. 5, 2005 (JP) 2005-256737

(51) Int. Cl. G02F 1/1337

(52) U.S. Cl. 349/124

(57) ABSTRACT

The present invention provides a method for producing an optical sheet by using a rubbing method comprising running a belt-like flexible support and bringing a rotating rubbing roller into contact with a surface of the belt-like flexible support for performing an orientation process, wherein a rubbing cloth wound around a surface of the rubbing roller has a filament size of from 1.0 to 2.5 deniers. According to the present invention, it is possible to significantly reduce surface defects caused by poor orientation in the production of optical materials, in particular, in the production of optical compensation films.

### BACKGROUND OF THE INVENTION

1. Field of the Invention

The present invention relates to a rubbing apparatus and a method for producing optical sheets, in particular to a rubbing apparatus and a method for producing optical sheets suitable for obtaining optical materials with significantly reduced surface defects.

2. Description of the Related Art

In recent years, optical films are now in increasing demand. These optical films are typified by films with various functions such as optical compensation films used as phase difference plates for liquid crystal cells, antireflection films and antiglare films.

A representative example of the method for producing these optical films includes a method comprising subjecting a surface of a belt-like flexible support (hereinafter referred to as a “web”) to a rubbing process (orientation process), applying a coating solution to the surface of the web using various coating apparatuses, drying the coating solution and then curing the dried coating, thereby forming coating films (functional films) of various compositions.

In the rubbing process which is introduced into the production of optical films or the like, it has been known that the properties of materials of rubbing cloth wound around rubbing rollers significantly influence the result of the orientation. For example, Japanese Utility Model No. 3032820 discloses a proposal on the properties of materials of rubbing cloth.

Japanese Utility Model No. 3032820 proposes a rubbing cloth which has a velvet weave having numbers of flocculent cut piles composed of viscose rayon filaments on one surface, in which the cut piles are retained in the state inclined in the direction of ground warps of the ground weave by a predetermined angle such that they are elastically deformable by bending. It also proposes that a cloth of the above structure enables precise formation of fine grooves in the orientation process.

### SUMMARY OF THE INVENTION

Japanese Utility Model No. 3032820 is, however, poor in describing specific effects and may be insufficient to improve the orientation. In addition, the measures to solve problems such as image defects cannot be found therein in the case where it is applied to the production of optical compensation films or the like.

Moreover, detail investigations of the rubbing cloth on the filament size and the filament density thereof have not been carried out. Accordingly, there is substantially no guideline to obtain rubbing cloth that improve the orientation by rubbing.

The present invention has been created in view of these circumstances, and it is an object of the present invention to provide a rubbing method, a rubbing apparatus and a method for producing optical sheets which can significantly reduce surface defects caused by poor orientation in the production of optical materials, in particular, in the production of optical compensation films and the like.

In order to achieve the above object, the present invention provides a method for producing an optical sheet by using a rubbing method comprising: bringing a rotating rubbing roller into contact with a surface of the belt-like flexible support for performing an orientation process while running the belt-like flexible support, wherein a rubbing cloth wound around a surface of the rubbing roller has a filament size of from 1.0 to 2.5 deniers.

According to the present invention, in the rubbing process, the rubbing cloth wound around a surface of the rubbing roller has a filament size of from 1.0 to 2.5 deniers. That is, as a result of various investigations on the rubbing cloth by the present inventors, the optimal range of the filament size of the rubbing cloth has been found. This has made it possible to significantly reduce surface defects caused by poor orientation in the production of optical materials, in particular, in the production of optical compensation films.

Specifically, when the filament size is less than 1.0 denier, the degree of extinction may be reduced due to the lack of rubbing, or the orientation may be too low because filaments are likely to be worn, and defective conditions are likely to occur thereby. On the other hand, when the filament size of the rubbing cloth is more than 2.5 deniers, the elasticity of the rubbing cloth may be too high, and the cloth may rub the orientation layer too strongly, which may produce fine powders and surface defects are likely to occur thereby. Therefore, both cases are not preferred.

Here, the optical materials include materials having various functions such as optical films, touch panels and electronic paper, and the optical films include films having various functions such as optical compensation films, antireflection films and antiglare films.

In the present invention, the rubbing cloth preferably has a filament density of from 25,000 to 150,000 filaments/cm². As a result of various investigations on the rubbing cloth by the present inventors, the optimal range of the filament density of the rubbing cloth has been found similarly. This has made it possible to significantly reduce surface defects caused by poor orientation in the production of optical materials, in particular, in the production of optical compensation films.

That is, when the density of the filament is less than 25,000 filaments/cm², the degree of extinction may be reduced due to the lack of rubbing, or the orientation may be too low because filaments are likely to be worn, and defective conditions are likely to occur thereby. On the other hand, when the density of the filament of the rubbing cloth is more than 150,000 filaments/cm², filaments are likely to be lost or fall off, which may produce fine powders and surface defects are likely to occur thereby. In addition, the latter case may increase cost. Therefore, both cases are not preferred.

Further, in the present invention, the rubbing cloth preferably has a filament made of a rayon filament fiber. When the rubbing cloth has a filament made of a rayon filament fiber, the orientation layer can be easily controlled in the optimal state during the rubbing process.

Furthermore, in the present invention, the substrate is preferably a belt-like flexible support. The effect of the present invention can be further developed by such a belt-like flexible support.

Moreover, the present invention provides a method for producing an optical sheet comprising continuously running a belt-like flexible support and bringing a rotating rubbing roller into contact with a surface of the belt-like flexible support for performing an orientation process, and applying a coating solution by a coating device to the surface of the support after the orientation process to form a functional film, wherein a rubbing cloth wound around a surface of the rubbing roller has a filament size of from 1.0 to 2.5 deniers.

In the present invention, the support is preferably a polymer film.

The effect of the present invention can be further developed by a belt-like flexible support, in particular, by a support made of a polymer film, in the production of optical materials such as optical compensation films.

As described above, the present invention can significantly reduce surface defects caused by poor orientation.

### BRIEF DESCRIPTION OF THE DRAWINGS

FIG. 1 is a schematic drawing illustrating an optical film production line to which a rubbing apparatus and a method for producing optical sheets according to the present invention are applied;

FIG. 2 is a sectional view illustrating the configuration of a bar coating apparatus;

FIGS. 3A and 3B are partially enlarged perspective views illustrating the configuration of rubbing cloth;

FIG. 4 is a schematic drawing illustrating another embodiment of the production line of optical films to which the rubbing apparatus and the method for producing optical sheets according to the present invention are applied;

FIGS. 5A and 5B are table illustrating the results of examples; and

FIG. 6 is a graphical representation illustrating the results of examples.

### DETAILED DESCRIPTION OF THE PREFERRED EMBODIMENTS

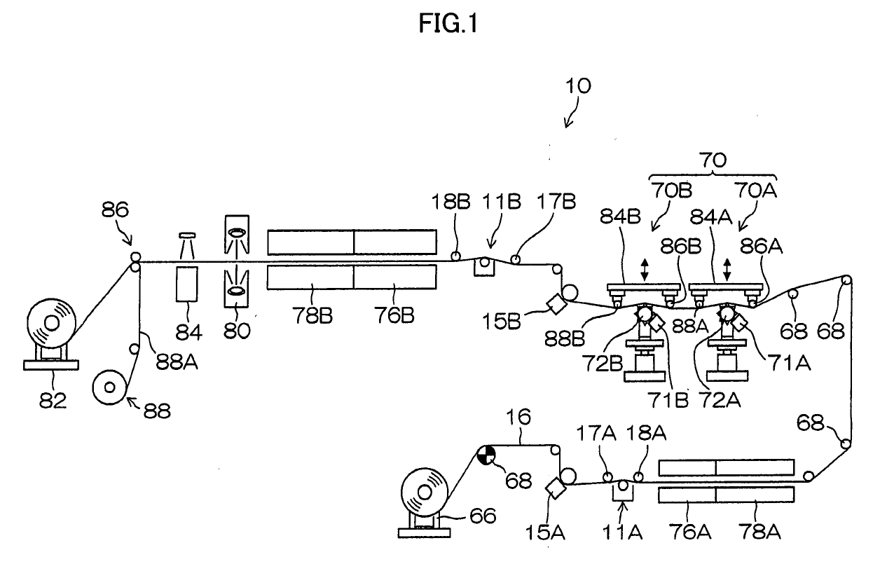

A preferred embodiment of a rubbing apparatus and a method for producing optical sheets according to the present invention will now be described in detail below in accordance with the attached drawings. FIG. 1 is a schematic drawing illustrating an optical film production line to which a rubbing apparatus and a method for producing optical sheets according to the present invention are applied.

As shown in FIG. 1, an optical film production line 10 comprises a feeder 66 adapted to feed a web 16 which is a transparent support. The web 16 is guided by a guide roller 68 so that it passes through a dust remover 15A. The dust adhered to the surface of the web 16 can be removed by the dust remover 15A.

Various known types of dust removers can be adopted as the dust remover 15A. For example, there can be adopted a dust remover which has a structure of blowing compressed air (or nitrogen gas), from which dust is electrostatically removed, on the surface of the web 16 so as to remove the dust adhered to the surface of the web 16.

A bar coating apparatus 11A is provided downstream of the dust remover 15A so that a coating solution containing an orientation layer-forming resin can be applied to the web 16. A drying zone 76A and a heating zone 78A are sequentially provided downstream of the bar coating apparatus 11A so that an orientation layer can be formed on the web 16.

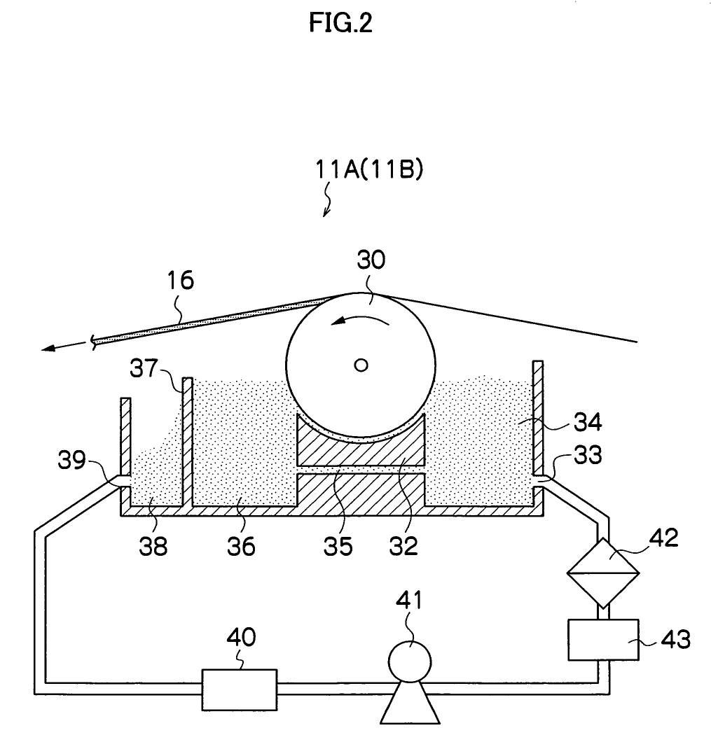

FIG. 2 is a sectional view of the bar coating apparatus 11A. In the bar coating apparatus 11A, a wire bar 30 is supported by bearings (not shown) at both ends thereof and by a backup block 32 at the part between the bearings. An end of the wire bar 32 is coupled to a motor (not shown) via a coupling.

The coating solution is fed from a liquid supply port 33, passes through a primary side liquid reservoir 34 and a connecting pipe 35, and is packed into a secondary side liquid reservoir 36. The level of the primary side liquid reservoir 34 and the secondary side liquid reservoir 36 is regulated by a level regulating plate 37, and the coating solution overflowed from the level regulating plate 37 is discharged from a liquid discharge port 39 via an overflow liquid reservoir 38.

To the discharged coating solution, are added a new coating solution and optionally a solvent at a viscosity adjustment chamber 40 to adjust the liquid to an appropriate viscosity. The viscosity-adjusted coating solution is delivered by a pump 41, filtered in a filter 42 and then sent again to the liquid supply port 33. Incidentally, a density meter 43 is provided upstream of the filter 42 so that the viscosity is adjusted on the basis of the information on the liquid density from the density meter 43.

The coating solution is applied to a surface of the transported web 16 by bringing the wire bar 30 into contact with the surface directly or via the coating solution. The wire bar 30 is generally obtained by closely winding a wire having a diameter of from 20 to 150 μm around a rod having a diameter of from 5 to 20 mm. The application of the coating solution is carried out by rotating the wire bar 30 in the same direction as the transport direction of the web 16 at substantially the same speed as the transport speed thereof and bringing the coating solution, which is raised from the primary side liquid reservoir 34, into contact with the web 16.

Incidentally, the bar coating apparatus 11A (11B) is only one example of coating devices, and coating devices other than the bar coating apparatus may be adopted. These coating devices include a gravure coater, a roll coater (transfer roll coater, reverse roll coater and the like), a die coater, an extrusion coater, a fountain coater, a curtain coater, a dip coater, a spray coater, a slide hopper and the like.

In FIG. 1, after applied with the coating solution and dried, the web 16 is guided by guide rollers 68 and fed to a rubbing process apparatus 70. The rubbing process apparatus 70 is composed of two rubbing process apparatuses 70A and 70B which are provided in series and have the same specification. A rubbing roller 72A (72B) is provided to subject a polymer layer (orientation layer) to a rubbing process. A dust remover 71A (71B) is provided upstream of the rubbing roller 72A (72B) so that it can remove the dust adhered to the surface of the web 16.

The rubbing apparatus 70 is the apparatus to subject the polymer layer to a rubbing process, and in the present embodiment, it has a two-stage roller structure composed of the rubbing rollers 72A and 72B. Alternatively, a one-stage roller structure can be adopted for the rubbing apparatus 70.

In the rubbing process apparatus 70A (70B), the rubbing roller 72A (72B), around the peripheral surface of which rubbing cloth to be described below is wound, is rotationally driven, and the rotational speed can be controlled, for example, up to about 1,000 rpm. The rubbing roller 72A (72B) has an outer diameter of, for example, 150 mm and a length of a little longer than the width of the web 16 in the state where it is inclined with a certain rubbing angle. In addition, the rubbing process apparatus 70A (70B) is adapted to be freely rotatable in the horizontal plane relative to the running direction of the web 16 so that the apparatus can be adjusted to any rubbing angle.

A roller stage 84A (84B) is provided above the rubbing roller 72A (72B), and backup rollers 86A (86B) and 88A (88B) are freely rotatably mounted on the lower side of the roller stage 84A (84B) via a spring. The backup rollers 86A (86B) and 88A (88B) are provided with a mechanism for detecting the tension of the web 16 so that the tension during rubbing can be controlled.

Furthermore, the backup rollers 86A (86B) and 88A (88B) can be vertically adjusted so that the wrap angle of the web 16 to the rubbing roller 72A (72B) can be adjusted by moving the rollers vertically.

By above described structure, the resin layer on the surface (lower surface) of the web 16 is rubbed with the rubbing roller 72A (72B) which is pressed from the lower side while the web 16 is pressed from the upper side by the backup rollers 86A (86B) and 88A (88B).

A dust remover 15B is provided downstream of the rubbing process apparatus 70 so that the dust adhered to the surface of the web 16 can be removed.

A bar coating apparatus 11B is provided downstream of the dust remover 15B so that a coating solution containing a disconematic liquid crystal can be applied to the web 16. The structure of the bar coating apparatus 11B is substantially the same as the above described bar coating apparatus 11A (refer to FIG. 2).

A drying zone 76B and a heating zone 78B are sequentially provided downstream of the bar coating apparatus 11B so that a liquid crystal layer can be formed on the web 16. Further, an ultraviolet lamp 80 is provided downstream of the drying zone 76B and the heating zone 78B so that the ultraviolet irradiation allows the liquid crystal to be crosslinked, thereby forming a desired polymer. Furthermore, the web 16 with a polymer formed thereon is inspected by an inspection apparatus 84, laminated with a protective film 88A delivered from a laminating machine 88 and wound by a winder 82 provided further downstream.

In the present embodiment, the entire optical film production line 10, in particular, the bar coating apparatuses 11A and 11B are preferably installed in a clean atmosphere such as a clean room. At this time, the cleanliness is preferably Class 1,000 or better, more preferably Class 100 or better, and most preferably Class 10 or better.

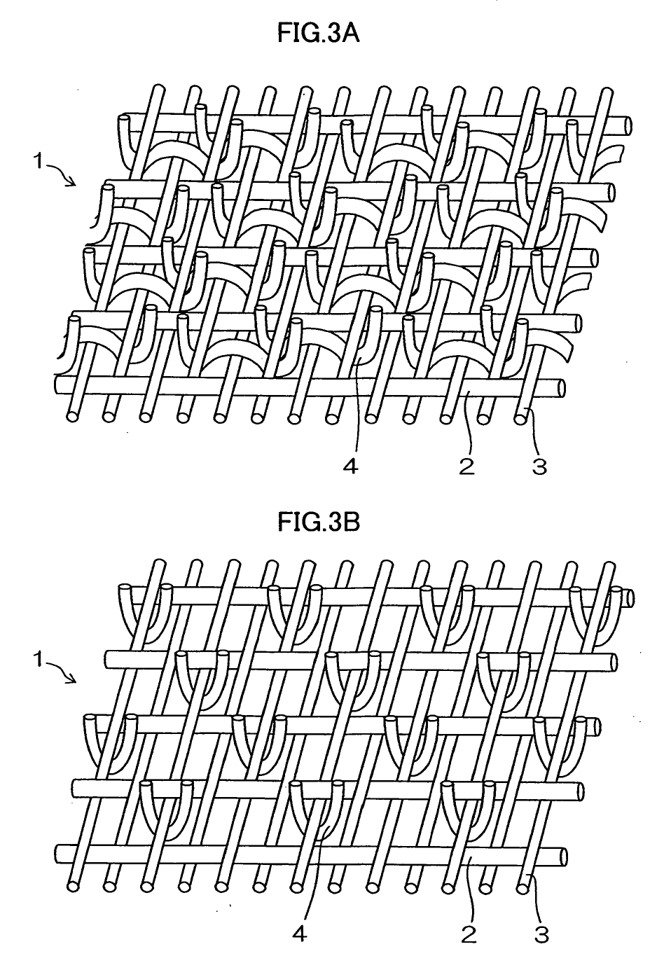

Next, a rubbing cloth which is the characteristic part of the present invention will be described. FIGS. 3A and 3B are partially enlarged perspective views illustrating the configuration of rubbing cloth 1. The rubbing cloth 1 is prepared by weaving filaments 4 into a base cloth which is prepared by weaving warps 2 of the ground weave and wefts 3 of the ground weave into a grid-like structure. The rubbing cloth prepared by weaving a filament 4 into three wefts 3 as shown in FIG. 3 A is called the W-weave, and that prepared by weaving a filament 4 into one weft 3 as shown in FIG. 3B is called the V-weave.

The fiber for the base cloth includes one type of fiber or a combination of two or more types of fibers selected from synthetic fibers including polyamides such as Nylon 6,6 (registered trade mark), polyesters such as polyethylene terephthalate, polyolefins such as polyethylene, polyvinyl alcohols, polyvinylidene chlorides, polyvinyl chlorides, acrylics such as polyacrylonitrile, acrylamide and methacrylamide, polyvinylidene cyanides, polyfluoroethylenes, polyurethanes and the like; natural fibers such as silk, cotton, wool, celluloses and cellulose esters; and regenerated fibers (rayon, acetate and the like).

These fiber materials preferably include polyamides such as Nylon 6 and Nylon 6, 6 (registered trade mark), acrylics such as polyacrylonitrile, acrylamide and methacrylamide, polyesters such as polyethylene terephthalate, and rayon and acetate from celluloses and cellulose esters as regenerated fibers.

A filament, in which, for example, 70 fibers of 1.4 deniers are twisted into a filament of about 100 deniers, is used as the warp 2 and weft 3 of the base cloth. As the warp 2 and weft 3, for example, cupra rayon (Bemberg) filament fiber manufactured by Asahi Kasei Corporation is preferably used.

The filament 4 preferably has a diameter of from 1.0 to 2.5 deniers, most preferably from 1.5 to 2.0 deniers. When the filament size is less than 1.0 denier, the degree of extinction may be reduced due to the lack of rubbing, or the orientation may be too low because filaments are likely to be worn, and defective conditions are likely to occur thereby. On the other hand, when the filament size of the rubbing cloth is more than 2.5 deniers, the elasticity of the rubbing cloth may be too high, and the cloth may rub the orientation layer too strongly, which may produce fine powders and surface defects are likely to occur thereby. Therefore, both cases are not preferred.

The density of the filament 4 is preferably from 25,000 to 150,000 filaments/cm². When the density of the filament is less than 25,000 filaments/cm², the degree of extinction may be reduced due to the lack of rubbing, or the orientation may be too low because filaments are likely to be worn, and defective conditions are likely to occur thereby. On the other hand, when the density of the filament of the rubbing cloth is more than 150,000 filaments/cm², filaments are likely to be lost or fall off, which may produce fine powders and surface defects are likely to occur thereby. In addition, the latter case may increase cost. Therefore, both cases are not preferred.

Moreover, the material of the filament 4 is preferably a rayon filament fiber. As the filament 4, for example, a rayon filament fiber manufactured by ENKA Corporation can be preferably used.

In the rubbing cloth, a sealer can be used so that the filament 4 is not lost from the base cloth (warp 2 and weft 3). The sealer to be used in the present invention includes one type selected from a synthetic resin emulsion made of, for example, polyvinyls, polyolefins, polyurethanes, polyamides, polyesters, synthetic rubbers, epoxies, phenols, acrylics and the like, a vinyl acetate resin/emulsion type, and a vinyl acetate resin/toluene solvent type, or a blend of two or more types thereof, or a copolymer emulsion prepared by a combination thereof.

Next, each material to form the optical film will be described. The optical compensation sheet obtained by the method for producing optical sheets of the present invention has a basic structure comprising a transparent resin film, an orientation layer provided thereon and a liquid crystal layer having a disconematic phase (also referred to as an optically anisotropic layer) formed on the orientation layer.

Any material can be used as the material for the transparent resin film as long as it is transparent. A material having a light transmittance of 80% or more is preferred, and a material having optical isotropy when viewed from the front is particularly preferred.

Accordingly, the transparent film is preferably produced from the materials having a small intrinsic birefringence. As such materials, cellulose triacetates {examples of commercially available products: Zeonex (manufactured by Zeon Corporation), ARTON (manufactured by Japan Synthetic Rubber Corporation) and Fujitac (manufactured by Fuji Photo Film Co., Ltd.)} can be used. Furthermore, the transparent film can be obtained even from those materials having a large intrinsic birefringence such as polycarbonates, polyallylates, polysulfones and polyethersulfones by appropriately setting conditions of solvent casting, melt extrusion or the like, conditions for stretching the film in the longitudinal and lateral directions, and the like.

Preferably, when the main refractive indices in the plane of a transparent support (transparent resin film) are designated by nx and ny; the main refractive index in the thickness direction of the film is designated by nz; and the thickness of the film is designated by d, the relationship of the main refractive indices of the three axes satisfies nz<ny=nx (negative uniaxiality), and the retardation represented by the formula: {(nx+ny)/2−nz]×d is in the range of from 20 nm to 400 nm (preferably from 30 to 150 nm).

However, the value of nx is not necessarily strictly equal to the value of ny, but it is sufficient as long as they are substantially equal. Specifically, there is no practical problem if the following formula is satisfied: |nx−ny|/|nx−nz|≦0.3. The front retardation represented by |nx−ny|×d is preferably 50 nm or less, more preferably 20 nm or less.

An orientation layer is typically provided on a transparent support. The orientation layer has a function of regulating the direction of the orientation of the liquid crystal discotic compound to be provided thereon. The orientation provides an optical axis which is inclined from the optical compensation sheet.

The orientation layer may be any layer as long as it can impart orientation to the optical anisotropy layer. Preferred examples of the orientation layer may include a layer of an organic compound (preferably polymer) which has been subjected to a rubbing process.

Examples of the organic compounds for the orientation layer may include polymers such as polymethylmethacrylates, acrylic acid/methacrylic acid copolymers, styrene/maleimide copolymers, polyvinyl alcohols, poly(N-methylolacrylamide), styrene/vinyl toluene copolymers, chlorosulfonated polyethylenes, nitrocellulose, polyvinyl chlorides, chlorinated polyolefins, polyesters, polyimides, vinyl acetate/vinyl chloride copolymers, ethylene/vinyl acetate copolymers, carboxymethyl cellulose, polyethylenes, polypropylenes and polycarbonates, and compounds such as silane coupling agents.

Examples of preferred polymers include polyimides, polystyrenes, polymers of styrene derivatives, gelatin, polyvinyl alcohols, and modified polyvinyl alcohols having an alkyl group (preferably having 6 or more carbon atoms). The orientation layer obtained by subjecting a layer of these polymers to an orientation process can orient a liquid crystal discotic compound in an inclined direction.

Among the above described polymers, polyvinyl alcohols or modified polyvinyl alcohols are preferred. Preferred polyvinyl alcohols have a degree of saponification of, for example, from 70 to 100%, typically from 80 to 100%, and more preferably from 85 to 95%, and preferably have a degree of polymerization in the range of from 100 to 3,000.

The modified polyvinyl alcohols include modified products of polyvinyl alcohols such as those modified by copolymerization (into which a modified group such as COONa, Si(OX)₃, N(CH₃)₃Cl, C₉H₁₉COO, SO₃Na, C₁₂H₂₅ or the like is introduced), those modified by chain transfer (in which a modified group such as COONa, SH, C₁₂H₂₅ or the like is introduced), those modified by block polymerization (into which a modified group such as COOH, CONH₂, COOR, C₆H₅ or the like is introduced) and the like. Modified polyvinyl alcohols preferably have a degree of polymerization in the range of from 100 to 3,000. Among the above described polymers, polyvinyl alcohols or modified polyvinyl alcohols are preferred. Preferably, unmodified or modified polyvinyl alcohols have a degree of saponification of from 80 to 100%, more preferably from 85 to 95%.

The modified polyvinyl alcohol is preferably a reaction product of a polyvinyl alcohol with a compound represented by general formula (1): 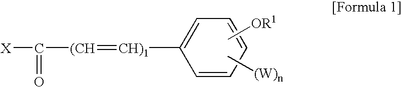
wherein R¹ denotes an unsubstituted alkyl group or an alkyl group substituted with an acryloyl group, a methacryloyl group or an epoxy group; W denotes a halogen atom, an alkyl group or an alkoxy group; X denotes a group of atoms required for forming an active ester, an acid anhydride and an acid halide; 1 denotes 0 or 1; and n denotes an integer of from 0 to 4.

Further, the reaction product (specific modified polyvinyl alcohol) is preferably a reaction product of a polyvinyl alcohol with a compound represented by general formula (2): 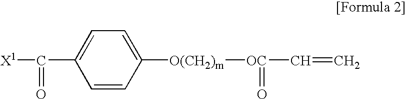
wherein X¹ denotes a group of atoms required for forming an active ester, an acid anhydride and an acid halide; and m denotes an integer of from 2 to 24.

The polyvinyl alcohols used for reacting with the compounds represented by general formulas (1) and (2) include the above described unmodified polyvinyl alcohols and the modified products of polyvinyl alcohols modified by copolymerization, chain transfer, block copolymerization or the like as described above.

Preferred examples of the specific polyvinyl alcohols include the compounds as described below. These compounds are described in detail in Japanese Patent Application No. 7-20583.

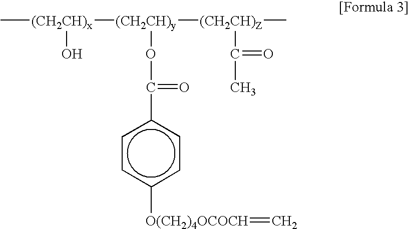

Examples of x, y and z (unit: % by mole) in the above general formula are shown below.
Polymer A: x=87.8, y=0.2, z=12.0
Polymer B: x=88.0, y=0.003, z=12.0
Polymer C: x=87.86, y=0.14, z=12.0
Polymer D: x=87.94, y=0.06, z=12.0
Polymer E: x=86.9, y=1.1, z=12.0
Polymer F: x=98.5, y=0.5, z=1.0
Polymer G: x=97.8, y=0.2, z=2.0
Polymer H: x=96.5, y=2.5, z=1.0
Polymer I: x=94.9, y=4. 1, z=1.0

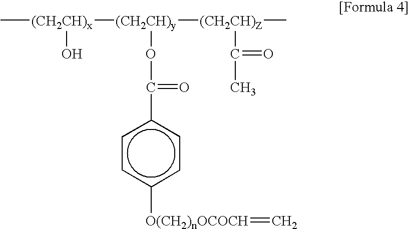

Examples of x, y and z (unit: % by mole) in the above general formula are shown below.
Polymer J: n=3, x=87.8, y=0.2, z=12.0
Polymer K: n=5, x=87.85, y=0.15, z=12.0
Polymer L: n=6, x=87.7, y=0.3, z=12.0
Polymer M: n=8, x=87.7, y=0.3, z=12.0

The values of the unit composing the polymers described below are shown in % by mole.

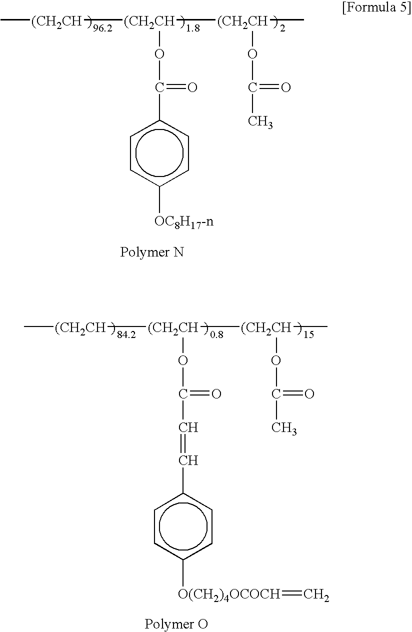

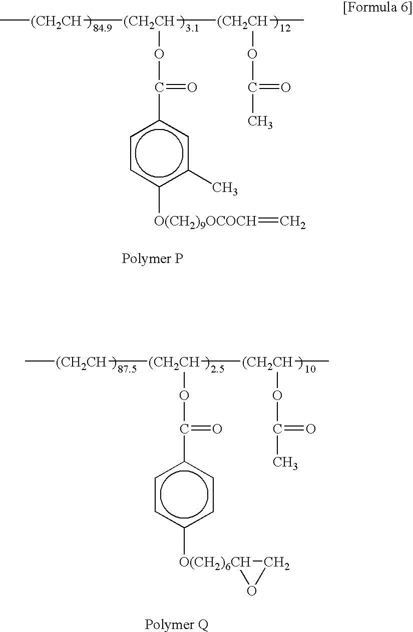

Moreover, a polyimide film (preferably fluorine atom-containing polyimide) which is widely used as the orientation layer of LCD is also preferred as the organic orientation layer. The film is obtained by coating polyamic acid (for example, LQ/LX series manufactured by Hitachi Chemical Co., Ltd., SE series manufactured by Nissan Chemical Industries, Ltd. or the like) on the surface of a support, firing the film at 100 to 300° C. for 0.5 to 1 hour, and then rubbing the fired film.

Moreover, in the rubbing process, the relative speed between the surface of the orientation layer and the rubbing cloth is typically from 50 to 1,000 m/min, and preferably from 100 to 500 m/min.

The liquid crystal layer having a discotic nematic phase is formed on the orientation layer. The liquid crystal layer of the present invention is a layer having negative birefringence which is obtained by orientating a liquid crystalline discotic compound and then cooling the same for solidification or by polymerizing (curing) a polymerizable liquid crystalline discotic compound.

Examples of the discotic compounds include benzene derivatives described in the research report by C. Destrade et al., Mol. Cryst., vol. 71, p. 111 (1981); toluene derivatives described in the research reports by C. Destrade et al., Mol. Cryst. Vol. 122, p. 141 (1985), and Physics lett., A, vol. 78, p. 82 (1990); cyclohexane derivatives described in the research report by B. Kohne et al., Angew. Chem. vol. 96, p. 70 (1984); azacrown or phenylacetylene macrocycles described in the research report by J. M. Lehn et al., J. Chem., Commun., p. 1794 (1985), and the research report by J. Zhang et al., J. Am. Chem. Soc. vol. 116, p. 2655 (1994); and the like.

The above described discotic (disk-like) compounds typically have a structure in which benzene, toluene, cyclohexane, azacrown or phenylacetylene as described above is positioned at the center of a molecule as the mother nucleus, and the mother nuclei is substituted with straight chain alkyl groups, alkoxy groups, substituted benzoyloxy groups or the like as the radially extending straight chains. The discotic compounds exhibit liquid crystallinity and include those compounds which are called as a discotic liquid crystal. However, the discotic compounds are not limited to those described above provided that the molecule itself has negative uniaxiality and can be imparted with a given orientation.

Preferred examples of the discotic compounds are shown below.

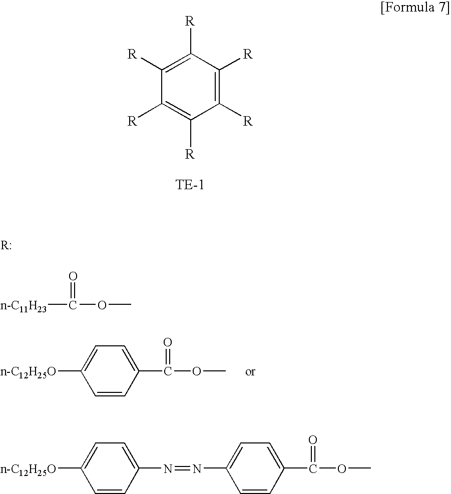

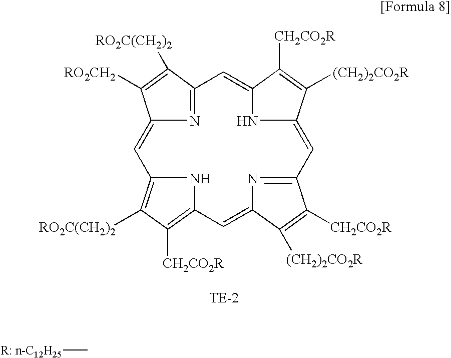

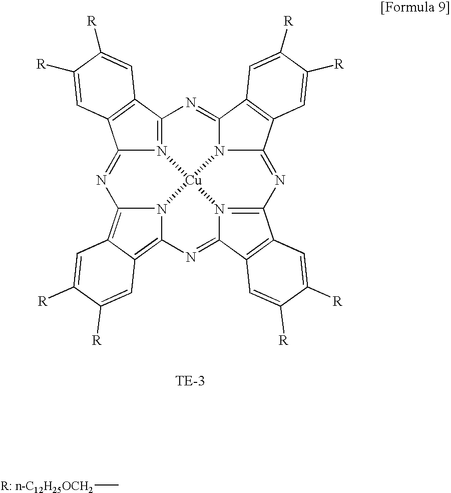

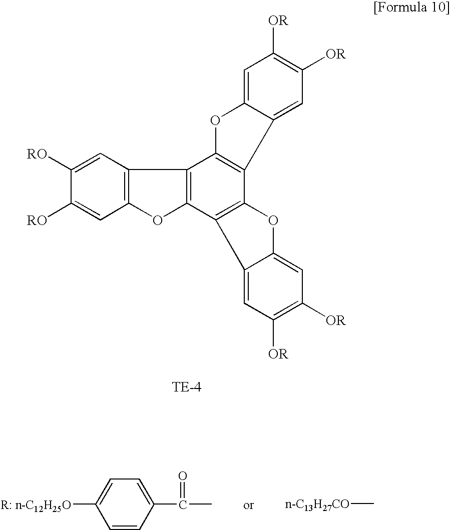

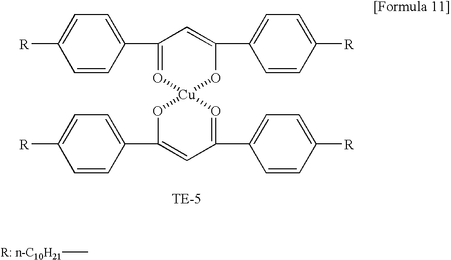

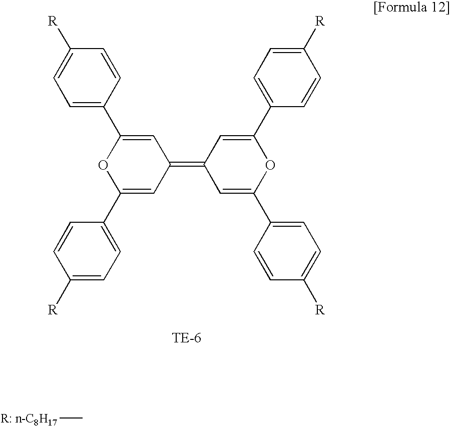

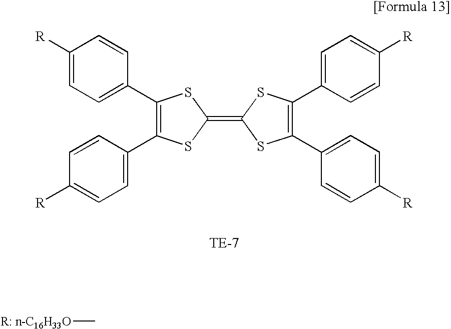

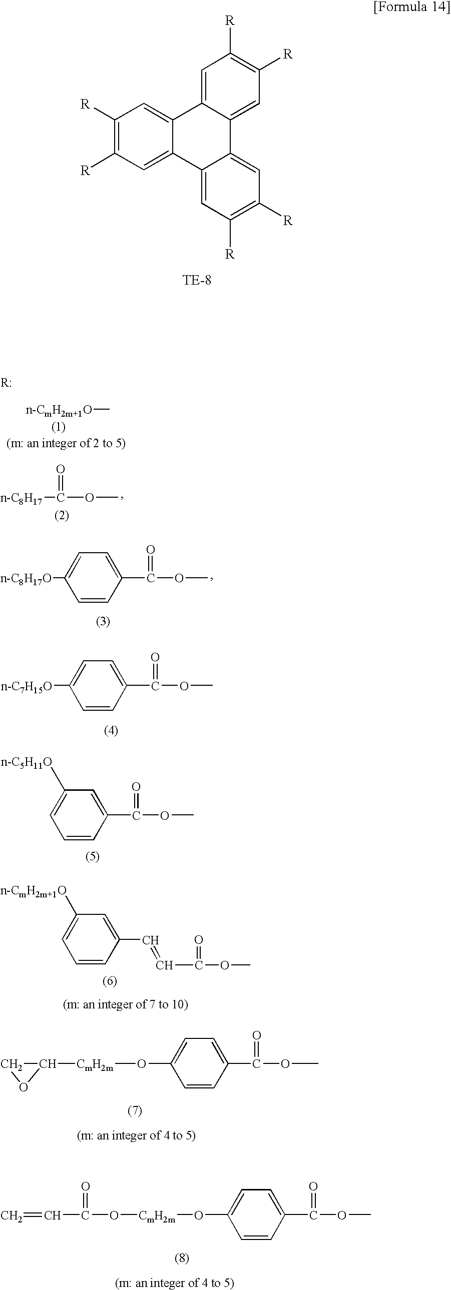

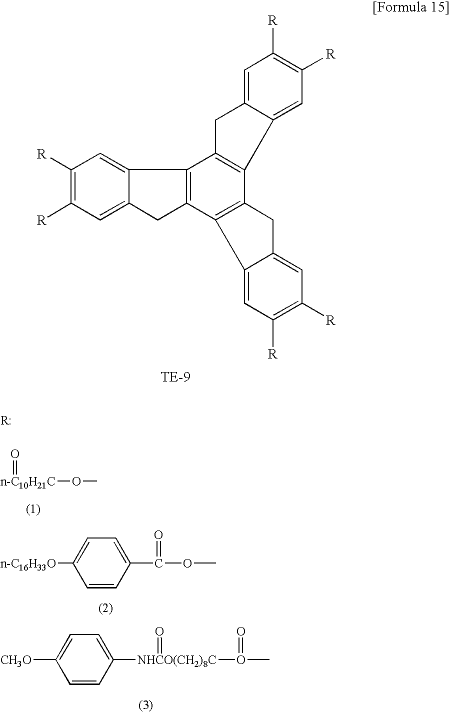

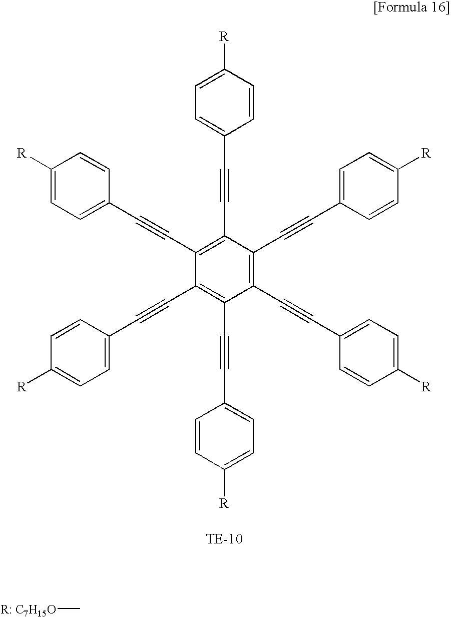

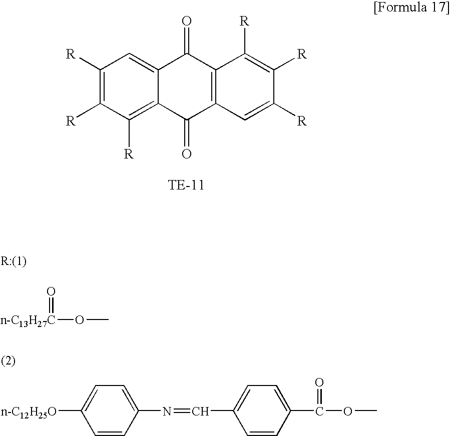

As described above, typically, a solution of a discotic compound and other compounds in a solvent is applied to the orientation layer, dried, heated to a temperature for forming the disconematic phase, and then cooled while maintaining the orientation state (discotic nematic phase), thereby obtaining the above described liquid crystal layer having a discotic nematic phase.

Alternatively, a solution of a discotic compound and other compounds (in addition, for example, a polymerizable monomer and a photopolymerization initiator) in a solvent is applied to the orientation layer, dried, heated to a temperature for forming a discotic nematic phase, and then polymerized (by the irradiation of UV light or the like), thereby obtaining the above described liquid crystal layer. The discotic nematic liquid crystal phase-solid phase transfer temperature of the discotic liquid crystalline compound used in the present invention is preferably from 70 to 300° C., more preferably from 70 to 170° C.

For example, the tilt angle of the discotic compound at the support (transparent resin film) side when it is oriented can be generally adjusted by selecting the material of the discotic compound or orientation layer or selecting the method of a rubbing process. Further, the tilt angle of the discotic unit at the surface side (air side) can be generally adjusted by selecting the discotic compound or other compounds (for example, plasticizers, surfactants, polymerizable monomers and polymers) to be used with the discotic compound. Furthermore, the extent of the change of the tilt angle can also be adjusted by the above described selection.

Any compounds can be used as the plasticizers, surfactants and polymerizable monomers as long as they are compatible with the discotic compound and can give the tilt angle to the liquid crystalline discotic compound or do not inhibit the orientation. Among others, polymerizable monomers (for example, compounds having a vinyl group, a vinyloxy group, an acryloyl group or a methacryloyl group) are preferred. These compounds are used in an amount of generally from 1 to 50% by weight (preferably from 5 to 30% by weight) based on the discotic compound.

Any polymers can be used as the above described polymers as long as they are compatible with the discotic compound and can give the tilt angle to the liquid crystalline discotic compound. Examples of the polymers include cellulose esters. Preferred examples of the cellulose esters include cellulose acetate, cellulose acetate propionate, hydroxypropyl cellulose and cellulose acetate butyrate.

These polymers are used in an amount of generally from 0.1 to 10% by weight (preferably from 0.1 to 8% by weight, most preferably from 0.1 to 5% by weight) so that they do not inhibit the orientation of the liquid crystalline discotic compound).

The obtained liquid crystal layer having a discotic nematic phase (optically anisotropic layer) generally has an absolute minimum value other than zero (does not have the optical axis) in the direction tilted from the direction of the normal of the optical compensation sheet.

In order to improve the viewing angle characteristics of TN-LCD and TFT-LCD, the direction showing the absolute minimum value of Re is preferably tilted by 5 to 50 degrees (average of the tilt), more preferably by 10 to 40 degrees, from the normal of the optically anisotropic layer.

Moreover, the above described sheet preferably satisfies the following condition:
50≦[(n3+n2)/2−n1]×D≦400 (nm)
(wherein D denotes the thickness of the sheet), and more preferably satisfies the following condition:
100≦[(n3+n2)/2−n1]×D≦400 (nm).

The coating solution for forming the liquid crystal layer having a disconematic phase can be prepared by dissolving the discotic compound and other compounds as described above in a solvent.

Examples of the solvents include polar solvents such as N,N-dimethylformamide (DMF), dimethylsulfoxide (DMSO) and pyridine; nonpolar solvents such as benzene and hexane; alkyl halides such as chloroform and dichloromethane; esters such as methyl acetate and butyl acetate; ketones such as acetone and methyl ethyl ketone; and ethers such as tetrahydrofuran and 1,2-dimethoxyethane. Alkyl halides and ketones are preferred. The solvent can be used singly or in combination.

As described above, the coating solution can be applied to the orientation layer, dried, heated above the glass transition temperature (then cured as desired) and cooled to obtain the optically anisotropic layer.

Next, a method for producing optical films using the optical film production line 10 shown in FIG. 1 will be described. First, the web 16 having a thickness of from 40 to 300 μm is fed from the feeder 66.

The web 16 is guided by the guide roller 68 and passes through the dust remover 15A, and the dust adhered to the surface of the web 16 is removed. At the downstream of the dust remover 15A, a coating solution containing an orientation layer-forming resin is applied to the web 16 by the bar coating apparatus 11A. Then, an orientation layer is formed on the web 16 in the drying zone 76A and the heating zone 78A.

The web 16 passed through the drying zone 76A and heating zone 78A is fed to the rubbing process apparatus 70, and the polymer layer thereof is subjected to the rubbing process by the rubbing rollers 72A and 72B.

Next, the dust adhered to the surface of the web 16 is removed by the dust remover 15B, and a coating solution containing a disconematic liquid crystal is applied to the web 16 by the bar coating apparatus 11B.

Subsequently, the web 16 passes through the drying zone 76B and heating zone 78B to form a liquid crystal layer thereon. The liquid crystal layer is then irradiated with the ultraviolet lamp 80 to crosslink the liquid crystal to form a desired polymer; Then, the web 16 with the polymer formed thereon is wound by the winder 82.

Although an embodiment of the method and the apparatus for producing optical films according to the present invention has been described above, the present invention is not limited to the above described embodiment, but various embodiments are possible.

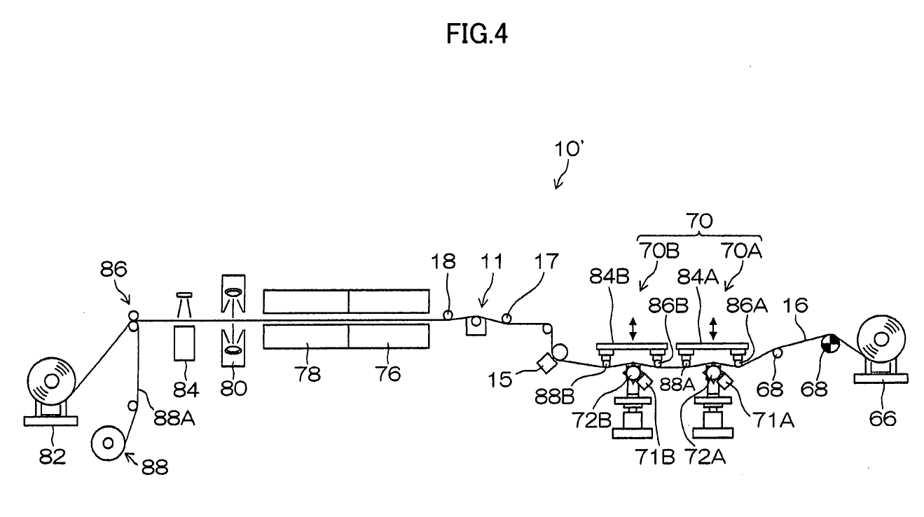

For example, in the present embodiment, a series of steps such as coating of the orientation layer, rubbing and coating of a coating solution containing the disconematic liquid crystal is executed in the same line from the feeder 66 to the winder 82. However, a production line other than the above can be adopted. FIG. 4 is a schematic drawing illustrating another embodiment of the optical film production line 10′. Incidentally, the same reference numerals are applied to the same members as or similar members to those in FIG. 1, and the detail thereof is omitted.

This production line does not have the step of forming the orientation layer in the upstream side of a rubbing process apparatus 70. That is, a web 16, on which the orientation layer is formed in a separate line, is fed from a feeder 66.

Moreover, a coating solution containing the disconematic liquid crystal is illustrated as the coating solution in the present embodiment, but coating solutions for other types of optical films, coating solutions for other applications than optical films, and the like can also be used.

### EXAMPLES

Optical films (optical compensation films) have been produced under various conditions using the optical film production line 10 as shown in FIG. 1.

In (the first half section of) the optical film production line 10 shown in FIG. 1, a 5% by weight solution of a long-chain alkyl modified-polyvinyl alcohol (MP-203, manufactured by Kuraray Co., Ltd.) was applied to one surface of long lengths of the web 16 made of triacetyl acetate (Fujitac, manufactured by Fuji Photo Film Co., Ltd., thickness: 100 μm, width: 500 mm), dried at 90° C. for 4 minutes and subjected to a rubbing process, thereby forming a resin layer for forming the orientation layer having a film thickness of 2.0 μm. The conveying speed of the web 16 was adjusted to 20 m/min.

In the rubbing process apparatus 70, the surface of the resin layer was subjected to a rubbing process while the web 16 was continuously conveyed at a speed of 20 m/min. The rubbing process was carried out at a number of revolutions of the rubbing roller 72 of 300 rpm. As the rubbing cloth 1, 5 types for Examples and 4 types for Comparison Examples were used.

In Example 1, the rubbing cloth 1 has a filament size of 1.5 deniers and a filament density of 146,000 filaments/cm². In Example 2, the rubbing cloth 1 has a filament size of 2.0 deniers and a filament density of 28,000 filaments/cm². In Example 3, the rubbing cloth 1 has a filament size of 2.1 deniers and a filament density of 28,000 filaments/cm². In Example 4, the rubbing cloth 1 has a filament size of 2.5 deniers and a filament density of 25,600 filaments/cm². In Example 5, the rubbing cloth 1 has a filament size of 1.0 denier and a filament density of 146,000 filaments/cm².

In Comparative Example 1, the rubbing cloth 1 has a filament size of 2.6 deniers and a filament density of 25,600 filaments/cm². In Comparative Example 2, the rubbing cloth 1 has a filament size of 3.0 deniers and a filament density of 25,600 filaments/cm². In Comparative Example 3, the rubbing cloth 1 has a filament size of 1.0 denier and a filament density of 160,000 filaments/cm². In Comparative Example 4, the rubbing cloth 1 has a filament size of 0.9 denier and a filament density of 24,000 filaments/cm².

Incidentally, a sealer made of an acrylic resin was used as the sealer of the rubbing cloth 1 in all examples.

After the rubbing process, the obtained web 16 having the orientation layer thereon was continuously conveyed at a speed of 20 m/min. To a mixture of the discotic compounds TE-8 (3) and TE-8 (5) in a weight ratio of 4:1, was added a photopolymerization initiator (Irgacure 907, manufactured by Nihon Ciba-Geigy K.K.) in an amount of 1% by weight based on the mixture of the discotic compounds, forming a mixture of the discotic compounds and the photopolymerization initiator. The orientation layer was coated with a 10% by weight methyl ethyl ketone solution of the above described mixture (coating solution) in a coating amount of 5 ml/m² by the bar coating apparatus 11B, and then passed through the drying zone 76B and heating zone 78B.

To the drying zone 76B, was sent an air flow of 0.1 m/sec, and the heating zone 78B was adjusted to 130° C. The web 16 entered into the drying zone 76B after 3 seconds from the completion of the coating and then entered into the heating zone 78B after additional 3 seconds. The web 16 passed through the heating zone 78B in about 3 minutes.

Then, the web 16 on which the orientation layer and the liquid crystal layer is applied was continuously conveyed at a speed of 20 m/min, and during the conveyance the surface of the liquid crystal layer was irradiated with ultraviolet light by the ultraviolet lamp 80. Specifically, the web 16 which had passed through the heating zone 78B was irradiated with an ultraviolet light having an illuminance of 600 mW for 4 seconds by the ultraviolet lamp 80 (output: 160 W/cm, luminous length: 1.6 m) to crosslink the liquid crystal layer.

Further, the web 16 with the orientation layer and the liquid crystal layer formed thereon was measured and inspected for the optical properties of the surface by the inspection apparatus 84, laminated with the protective film 88A delivered from the laminating machine 88 on the surface of the liquid crystal layer, and wound by the winder 82, thus obtaining an optical compensation film.

The obtained optical compensation films were evaluated for the following 4 types of evaluations: 1) Evaluation of orientation by the degree of extinction; 2) Evaluation of orientation by Schlieren defects; 3) Evaluation of sweep streaks; and 4) Evaluation of the number of dust particles.

1) Evaluation of Orientation by the Degree of Extinction

An apparatus for measuring the degree of extinction manufactured by Otsuka Electronics Co., Ltd. was used for the evaluation of orientation by the degree of extinction. In this apparatus, the wavelength of measurement was 550 nm, and the transmittance of the polarizing plate in the parallel Nicol arrangement was 100%. Two discotic liquid crystals in the crossed Nicol arrangement were evaluated for the orientation. In the evaluation of orientation by the degree of extinction, a lower degree of extinction means a higher degree of orientation.

2) Evaluation of Orientation by Schlieren Defects

Photographs were taken by a polarizing microscope (manufactured by Nikon Corporation, model: ECLIPSE E600 POL) for the evaluation of orientation by Schlieren defects. The Schlieren defects refer to dot defects produced when the orientation of the liquid crystal phase becomes worse. The films were evaluated for the number of dots (the number of Schlieren defects).

3) Evaluation of Sweep Streaks

Photographs were taken by a polarizing microscope (manufactured by Nikon Corporation, model: ECLIPSE E600 POL) for the evaluation of sweep streaks which are the defects of orientation. The sweep streaks refer to linear streak defects caused by the orientation state of the liquid crystal. The sweep streaks are rated by the following 4-stage evaluation: E: orientation is good; G: orientation is in an ordinary level; M: orientation is a little inferior; and P: orientation is poor.

4) Evaluation of the Number of Dust Particles

Evaluation of the number of dust particles was carried out by counting the number of duct particles having a particle size of 0.3 μm or less using a dust measuring device (manufactured by Kondoh Industries, Ltd., trade name: MicroAir-300BS).

Conditions of the rubbing cloth and the results of the above evaluations are shown in the table of Fig. SA. This table also shows an overall evaluation of the above evaluations 1) to 4). The overall evaluation is represented by the following 4-stage evaluation: E: excellent, G: good, M: marginal, and P: poor.

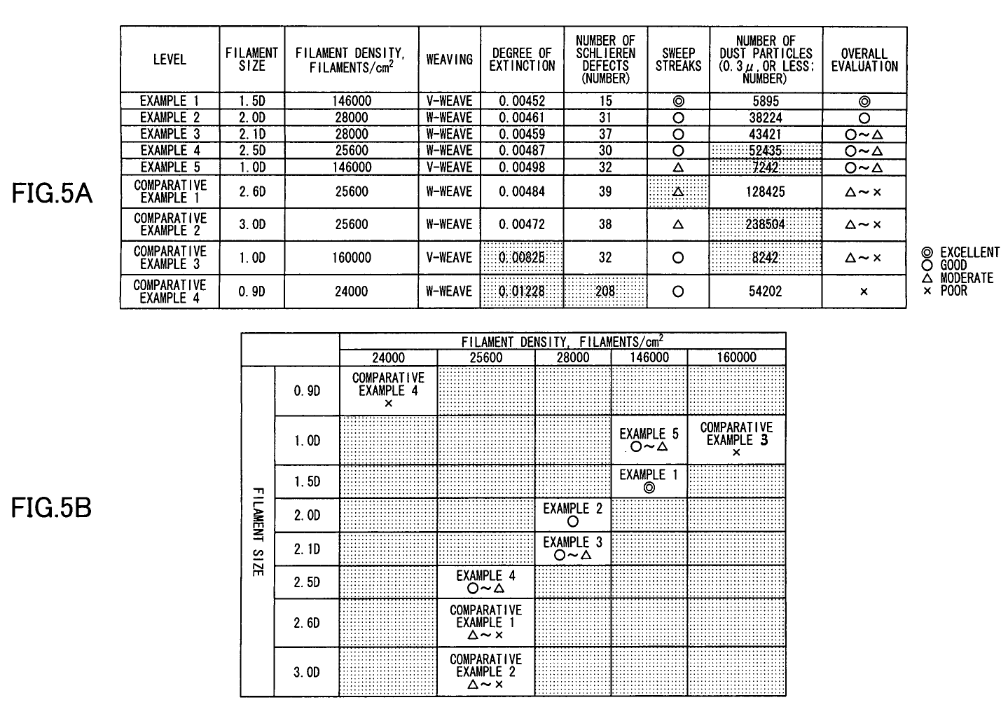

Further, conditions of the rubbing cloth and the overall evaluation are shown in the table of FIG. 5B. In the table, the column shows the filament size of the rubbing cloth, and the row shows the filament density of the rubbing cloth.

The results in the table revealed that the overall evaluation including the evaluation of orientation was good in the conditions where the rubbing cloth had a filament size of from 1.0 to 2.5 deniers and a filament density of from 25,000 to 150,000 filaments/cm².

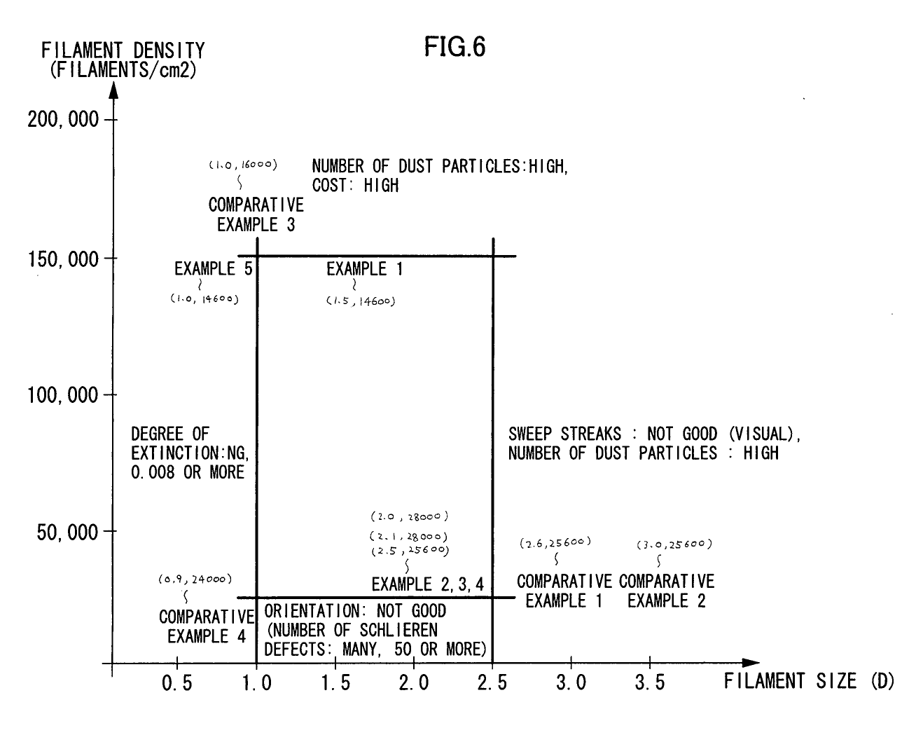

Furthermore, conditions of the rubbing cloth and the overall evaluation are shown in the graphical representation of FIG. 6. In the graphical representation, the ordinate shows the filament size of the rubbing cloth, and the abscissa shows the filament density of the rubbing cloth. The graphical representation also revealed that the overall evaluation including the evaluation of orientation was good in the conditions where the rubbing cloth had a filament size of from 1.0 to 2.5 deniers and a filament density of from 25,000 to 150,000 filaments/cm², that is, in the area inside the rectangle in the graphical representation.

On the other hand, at the right side of the rectangle in the graphical representation, 3) evaluation of sweep streaks and 4) evaluation of the number of dust particles are not good; at the left side of the rectangle in the graphical representation, 1) evaluation of orientation by the degree of extinction is not good; at the upper side of the rectangle in the graphical representation, 4) evaluation of the number of dust particles is not good and coat may be high; at the lower side of the rectangle in the graphical representation, 2) evaluation of orientation by Schlieren defects is not good. All of them are inadequate conditions.

What is claimed is:

1. A method for producing an optical sheet by using a rubbing method comprising:
bringing a rotating rubbing roller into contact with a surface of the belt-like flexible support for performing an orientation process while running the belt-like flexible support,
wherein a rubbing cloth wound around a surface of the rubbing roller has a filament size of from 1.0 to 2.5 deniers.

2. The method for producing an optical sheet according to claim 1, wherein the rubbing cloth has a filament density of from 25,000 to 150,000 filaments/cm².

3. The method for producing an optical sheet according to claim 1, wherein the rubbing cloth has a filament made of a rayon filament fiber.

4. The method for producing an optical sheet according to claim 2, wherein the rubbing cloth has a filament made of a rayon filament fiber.

5. The method for producing an optical sheet according to claim 1, wherein the belt-like flexible support is a polymer film.

6. The method for producing an optical sheet according to claim 2, wherein the belt-like flexible support is a polymer film.

7. The method for producing an optical sheet according to claim 3, wherein the belt-like flexible support is a polymer film.

8. The method for producing an optical sheet according to claim 4, wherein the belt-like flexible support is a polymer film.

9. A rubbing apparatus for running a belt-like flexible support and bringing a rotating rubbing roller into contact with a surface of the belt-like flexible support for performing an orientation process, wherein a rubbing cloth wound around a surface of the rubbing roller has a filament size of from 1.0 to 2.5 deniers.
